(19) United States
(12) Patent Application Publication
(10) Pub. No.: US 2026/0119561 A1
(43) Pub. Date: Apr. 30, 2026

(54) ELECTRONIC DEVICE AND ARTICLE SUMMARY GENERATION METHOD

(71) Applicant: ASUSTeK COMPUTER INC., Taipei City (TW)

(72) Inventors: Shih-Chieh Liao, Taipei City (TW); Chin-Hao Chang, Taipei City (TW); Tzu-Hung Chuang, Taipei City (TW); Shih-Chuan Chiu, Taipei City (TW); Yi-Nan Lee, Taipei City (TW)

(73) Assignee: ASUSTeK COMPUTER INC., Taipei City (TW)

(21) Appl. No.: 19/211,328

(22) Filed: May 19, 2025

(30) Foreign Application Priority Data
Oct. 25, 2024 (TW) 113140888

(51) Int. Cl. G06F 16/34; G06F 40/284

(52) U.S. Cl. CPC G06F 16/345; G06F 40/284

(57) ABSTRACT

An electronic device and an article summary generation method are provided. The method is adapted to the electronic device and includes the following steps. An original long text is obtained. The original long text is split into multiple first text segments according to a word limit. The first text segments are combined into multiple first text chunks according to the word limit. Each first text chunk includes at least one of the first text segments. The first text chunks are respectively input into a large language model to obtain multiple first preliminary summary texts respectively corresponding to the first text chunks. A final summary text of the original long text is generated based on the first preliminary summary texts.

### CROSS-REFERENCE TO RELATED APPLICATION

This application claims the priority benefit of Taiwan application serial no. 113140888, filed on Oct. 25, 2024. The entirety of the above-mentioned patent application is hereby incorporated by reference herein and made a part of this specification.

### BACKGROUND

### Technical Field

This disclosure relates to an electronic device and an article summary generation method.

### Description of Related Art

With the advent of the digital age, information explosion has become a major challenge in modern society. A large amount of text data, such as news reports, scientific papers, technical documents, and legal documents, is generated every day. In order to effectively extract key content from massive information, the application of large language models (LLM) has become particularly important in recent years. However, due to hardware limitations of computer devices (for example, handheld devices) and input limitations of the large language models themselves, when processing long articles or complex texts, accurate and complete summaries often cannot be effectively generated.

Currently, manual summarization of long articles consumes a lot of time and human resources, and the quality is unstable. Running the large language models through electronic devices with limited computing resources has stricter limitations on the length of input texts, which may easily lead to incomplete information in summaries or poor coherence of summaries. If keyword extraction or basic sentence extraction methods are used to generate summaries of long articles, core ideas and important information of the articles may not be fully captured.

### SUMMARY

The disclosure provides an article summary generation method, which is adapted to an electronic device and includes the following steps. An original long text is obtained. The original long text is split into multiple first text segments according to a word limit. The first text segments are combined into multiple first text chunks according to the word limit. Each first text chunk includes at least one of the first text segments. The first text chunks are respectively input into a large language model to obtain multiple first preliminary summary texts respectively corresponding to the first text chunks. A final summary text of the original long text is generated based on the first preliminary summary texts.

The disclosure provides an electronic device, including a storage device and a processor. The storage device records multiple commands. The processor is coupled to the storage device and is configured to execute the commands to execute the following operations. An original long text is obtained. The original long text is split into multiple first text segments according to a word limit. The first text segments are combined into multiple first text chunks according to the word limit. Each first text chunk includes at least one of the first text segments. The first text chunks are respectively input into a large language model to obtain multiple first preliminary summary texts respectively corresponding to the first text chunks. A final summary text of the original long text is generated based on the first preliminary summary texts.

Based on the above, in the embodiments of the disclosure, the original long text may be split into the first text segments according to the word limit, and the first text chunks may be generated through combining the first text segments. The first text chunks are sequentially input into the large language model to obtain the first preliminary summary texts respectively corresponding to the first text chunks through the large language model with a text summarization function. Therefore, the final summary text of the original long text may be further generated according to the first preliminary summary texts. Based on this, even if the original long text is lengthy and the computing resources of the electronic device are limited, the coherent and high-quality summary text can still be generated.

### BRIEF DESCRIPTION OF THE DRAWINGS

FIG. 1 is a block diagram of an electronic device according to an embodiment of the disclosure.

FIG. 2 is a flowchart of an article summary generation method according to an embodiment of the disclosure.

FIG. 3 is a schematic diagram of an article summary generation method according to an embodiment of the disclosure.

FIG. 4 is a flowchart of splitting an original long text according to an embodiment of the disclosure.

FIG. 5 is a schematic diagram of generating multiple text chunks according to an embodiment of the disclosure.

FIG. 6 is a flowchart of an article summary generation method according to an embodiment of the disclosure.

FIG. 7 is a schematic diagram of an article summary generation method according to an embodiment of the disclosure.

### DESCRIPTION OF THE EMBODIMENTS

Some embodiments of the disclosure will be described in detail with reference to the drawings. For the reference numerals cited in the following description, when the same reference numerals appear in different drawings, the reference numerals will be regarded as referring to the same or similar elements. The embodiments are only a part of the disclosure and do not disclose all possible implementations of the disclosure. More specifically, the embodiments are merely examples of a device and a method in the claims of the disclosure.

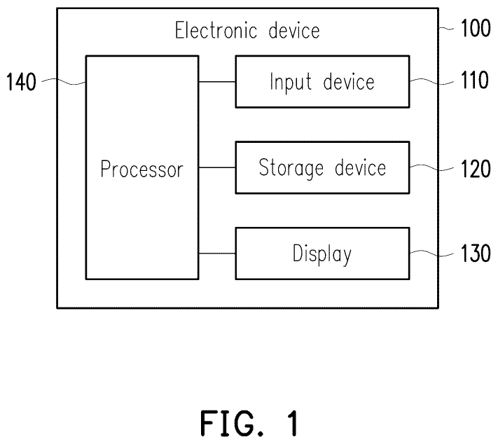

Please refer to FIG. 1. In the embodiment, an electronic device 100 may include an input device 110, a storage device 120, a display 130, and a processor 140. The electronic device 100 may be, for example, a smartphone, a notebook computer, a tablet computer, a desktop computer, etc., which is not limited in the disclosure. In addition, in some embodiments, the electronic device 100 may also be implemented by one or more electronic devices with computing abilities.

The input device 110 is configured to receive a user operation, such as touching an input device, a keyboard, or a mouse, which is not limited in the disclosure. In some embodiments, the input device 110 may be configured to receive the user operation, so that the electronic device 100 obtains an original long text.

The storage device 120 is configured to store data and software modules (for example, an operating system, an application, a driver) for access by the processor 140 and may be, for example, any type of fixed or removable random access memory (RAM), read-only memory (ROM), flash memory, hard disk, or a combination thereof.

The display 130 is, for example, a liquid crystal display (LCD), a light-emitting diode (LED) display, an organic light-emitting diode (OLED) display, or other types of displays, which is not limited in the disclosure. In some embodiments, the display 130 may display a user operation interface. The user operation interface allows a user to input an original long text or present a final summary text of the original long text.

The processor 140 is coupled to the input device 110, the storage device 120, and the display 130. The processor 140 is, for example, a central processing unit (CPU), an application processor (AP), other programmable general-purpose or specific-purpose microprocessors, digital signal processors (DSP), image signal processors (ISP), graphics processing units (GPU), other similar devices, an integrated circuit, and a combination thereof. In some embodiments, the processor 140 may access and execute the software modules recorded in the storage device 120 to implement an article summary generation method in an embodiment of the disclosure. The software modules may be broadly construed to mean commands, command sets, codes, program codes, programs, applications, software packages, threads, processes, functions, etc., whether referred to as software, firmware, middleware, microcode, hardware description language, or the like.

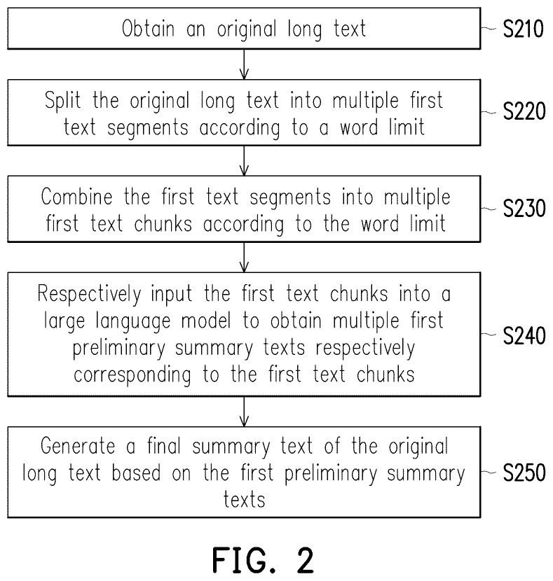

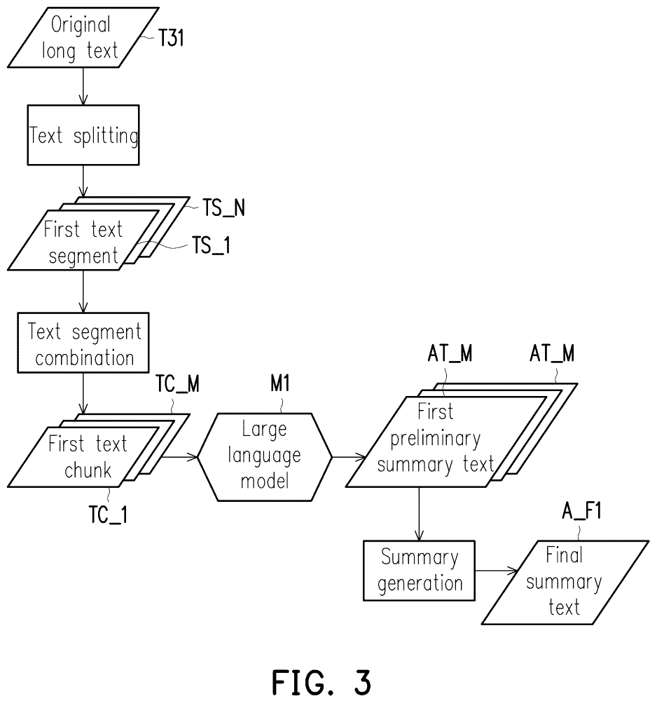

Please refer to FIG. 1 and FIG. 2 at the same time. The method of the embodiment is adapted to the electronic device 100. The detailed steps of the article summary generation method of the embodiment are described below in conjunction with various elements of the electronic device 100. In order to clearly describe possible implementations of the disclosure, the following description will be supplemented by FIG. 3. Please refer to FIG. 3 as well.

In step S210, the processor 140 obtains an original long text T31. In some embodiments, the user may provide the original long text T31 to the processor 140 through the user operation interface. For example, according to a file selection operation issued by the user, the processor 140 may read the original long text T31 from the storage device 120 or a cloud storage space. Alternatively, according to a text copy operation and a text paste operation issued by the user, the processor 140 may obtain the original long text T31 appearing in a web page.

In step S220, the processor 140 splits the original long text T31 into multiple first text segments TS_1 to TS_N according to a word limit. Specifically, the processor 140 may split the original long text T31 according to a preset upper limit of the number of words, and ensure that the number of words of each first text segment TS_1 to TS_N does not exceed the word limit. The splitting process may divide in terms of units of participles, sentences, or article paragraphs, thereby ensuring the integrity and coherence of the first text segments TS_1 to TS_N. In other words, the first text segments TS_1 to TS_N may include article paragraphs, sentences, participles, or combinations thereof.

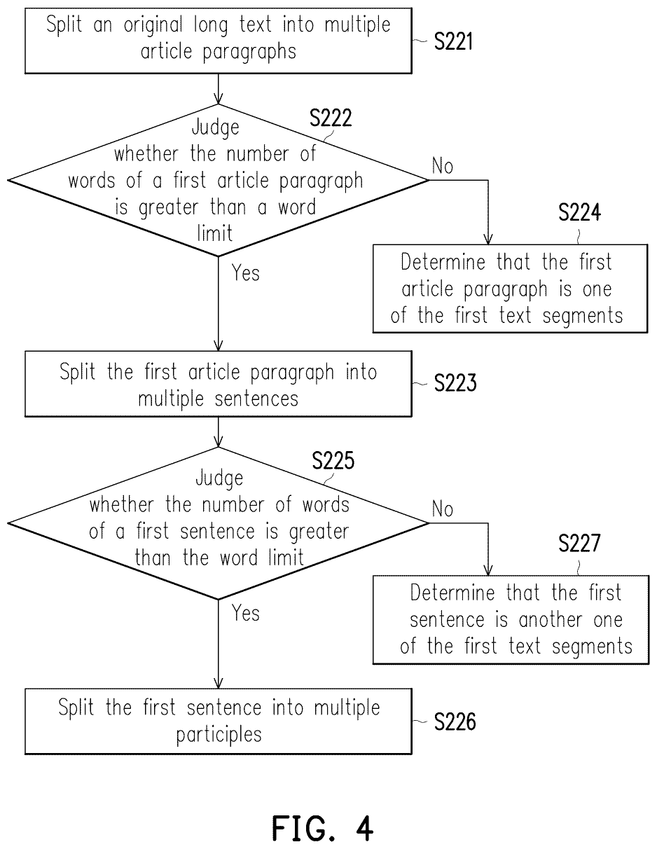

More specifically, the processor 140 may split the original long text T31 into a segment sequence including the first text segments TS_1 to TS_N according to the word limit. The first text segments TS_1 to TS_N sequentially arranged in the segment sequence may respectively be article paragraphs, sentences, or participles. Regarding the detailed implementation of splitting the original long text T31 into the first text segments TS_1 to TS_N, reference may be made to the description of the embodiment of FIG. 4 below.

In step S230, the processor 140 combines the first text segments TS_1 to TS_N into multiple first text chunks TC_1 to TC_M according to the word limit. Each first text chunk TC_1 to TC_M includes at least one of the first text segments TS_1 to TS_N. In other words, the number of first text segments included in each first text chunk TC_1 to TC_M may be different, and each first text chunk TC_1 to TC_M includes at least one first text segment. In some embodiments, based on the condition that the number of words of each first text chunk TC_1 to TC_M does not exceed the word limit, the sum of the number of words of the first text segments in each first text chunk TC_1 to TC_M is less than the word limit. That is, the processor 140 may generate the first text chunks TC_1 to TC_M based on the word limit, and confirm that the number of words of each first text chunk TC_1 to TC_M does not exceed the word limit.

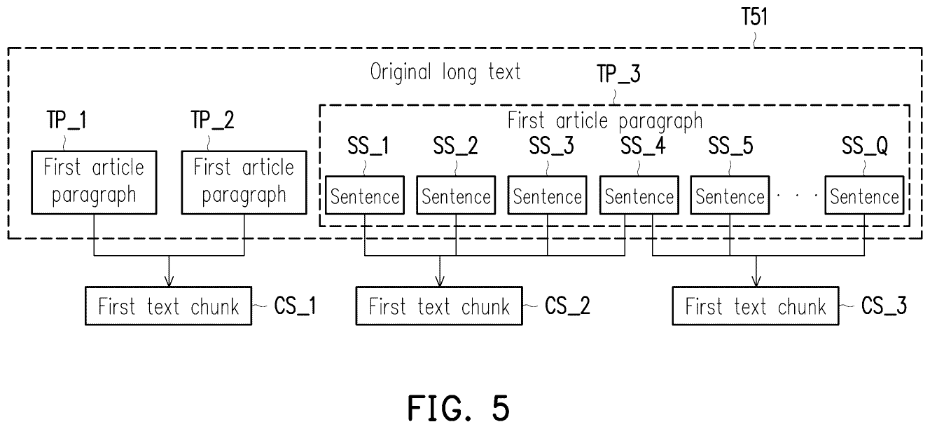

For example, the first text chunk TC_1 may include 2 first text segments, but another first text chunk TC_2 may include 3 first text segments. More specifically, under the condition of ensuring that each first text chunk TC_1 to TC_M does not exceed the preset word limit, the processor 140 may sequentially combine the first text segments TS_1 to TS_N in the segment sequence based on the word limit. Regarding the detailed implementation of combining the first text segments TS_1 to TS_N, reference may be made to the description of the embodiment of FIG. 5 below.

In step S240, the processor 140 respectively inputs the first text chunks TC_1 to TC_M into a large language model M1 to obtain multiple first preliminary summary texts AT_1 to AT_M respectively corresponding to the first text chunks TC_1 to TC_M.

In some embodiments, the processor 140 may tokenize each first text chunk TC_1 to TC_M, and convert each first text chunk TC_1 to TC_M into a token sequence that may be understood by the model. Afterwards, the token sequence of each first text chunk TC_1 to TC_M is input into the large language model M1, so that the large language model M1 may output the first preliminary summary text AT_1 to AT_M of each first text chunk TC_1 to TC_M. For example, the processor 140 may input the first text chunk TC_1 into the large language model M1, so that the large language model M1 may output the first preliminary summary text AT_1 of the first text chunk TC_1.

In different embodiments, the large language model M1 may be, for example, a large language model with a text summary generation function such as a generative pre-trained transformer (GPT) model, a bidirectional encoder representations from transformers (BERT) model, a bidirectional and auto-regressive transformer (BART) model, or a text-to-text transfer transformer (T5) model, which is not limited in the disclosure. The large language model M1 may process the first text chunks TC_1 to TC_M one by one to generate the exclusive first preliminary summary text AT_1 to AT_M for each first text chunk TC_1 to TC_M.

In step S250, the processor 140 generates a final summary text A_F1 of the original long text T31 based on the first preliminary summary texts AT_1 to AT_M. In some embodiments, when the sum of the number of words of the first preliminary summary texts AT_1 to AT_M does not exceed the word limit, the processor 140 may output a combined text of the first preliminary summary texts AT_1 to AT_M as the final summary text A_F1. When the sum of the number of words of the first preliminary summary texts AT_1 to AT_M exceeds the word limit, the processor 140 may perform text splitting on the combined text of the first preliminary summary texts AT_1 to AT_M again, and input the text chunks of the combined text of the first preliminary summary texts AT_1 to AT_M into the large language model again to generate the final summary text A_F1.

In some embodiments, the processor 140 may also perform optimization processing on the first preliminary summary texts AT_1 to AT_M, such as removing duplicate information, optimizing sentence structures, or adjusting sentence grammar. Afterwards, the processor 140 may combine the first preliminary summary texts AT_1 to AT_M after the optimization processing to generate the final summary text A_F1 based on the combined text of the first preliminary summary texts AT_1 to AT_M.

Please refer to FIG. 4, which is a flowchart of splitting an original long text according to an embodiment of the disclosure. In some embodiments, step S220 may be implemented as step S221 to step S227.

In step S221, the processor 140 splits an original long text into multiple article paragraphs. In some embodiments, the processor 140 may use some software tools (for example, pypdf2, python-docx, etc.) to perform reading according to paragraphs from a data source to obtain the article paragraphs of the original long text. The software tools may identify paragraph elements in a document or perform text splitting according to file format rules to split the original long text into the article paragraphs. Alternatively, in some embodiments, the processor 140 may use segmentation symbols (for example, \n and \r) to perform the text splitting to obtain the article paragraphs of the original long text.

In step S222, processor 140 judges whether the number of words of a first article paragraph among the article paragraphs is greater than a word limit. The word limit may be determined based on an input token limit of the large language model. The first article paragraph may be each of the article paragraphs.

In step S224, when the number of words of the first article paragraph among the article paragraphs is not greater than the word limit (judgement in step S222 is no), the processor 140 determines that the first article paragraph is one of the first text segments. In other words, when the number of words of a certain article paragraph of the original long text does not exceed the word limit, the processor 140 may directly identify the article paragraph as one first text segment.

On the other hand, in step S223, when the number of words of the first article paragraph among the article paragraphs is greater than the word limit (judgement in step S222 is yes), the processor 140 splits the first article paragraph into multiple sentences. In other words, when the number of words of a certain article paragraph of the original long text exceeds the word limit, the processor 140 may further split the article paragraph into multiple sentences. The processor 140 may further split the article paragraph into the sentences based on punctuation marks (for example, periods, etc.).

In step S225, the processor 140 judges whether the number of words of a first sentence among the sentences is greater than the word limit. The first sentence may be each of the sentences.

In step S226, when the number of words of the first sentence among the sentences is greater than the word limit (judgement in step S225 is yes), the processor 140 splits the first sentence into multiple participles. The first text segments include the participles. In some embodiments, the processor 140 may use a word segmentation algorithm (for example, a Chinese word segmentation algorithm or an English word segmentation tool) to cut a long sentence into multiple participles. In some embodiments, the processor 140 may cut the long sentence into the participles according to spaces or semantic units (for example, phrases).

In step S227, when the number of words of the first sentence among the sentences is not greater than the word limit (judgement in step S225 is no), the processor 140 determines that the first sentence is another one of the first text segments. In other words, when the number of words of the first sentence among the sentences does not exceed the word limit, the first text segments include the first sentence, that is, the first sentence is directly identified as another one of the first text segments.

Please refer to FIG. 5, which is a schematic diagram of generating multiple text chunks according to an embodiment of the disclosure. In the example of FIG. 5, the processor 140 splits an original long text T51 into 3 first article paragraphs TP_1 to TP_3. Since the number of words of the first article paragraphs TP_1 and TP_2 does not exceed the word limit, the processor 140 does not further split the first article paragraphs TP_1 and TP_2. Since the number of words of the first article paragraph TP_3 exceeds the word limit, the processor 140 splits the first article paragraph TP_3 into Q sentences SS_1 to SS_Q. In the example, since the number of words of the Q sentences SS_1 to SS_Q does not exceed the word limit, the processor 140 does not further split the sentences SS_1 to SS_Q. Based on this, the processor 140 may split the original long text T51 into (2+Q) first text segments.

Afterwards, the processor 140 combines the first article paragraphs TP_1 and TP_2 and generates a first text chunk C5_1. More specifically, in the example of FIG. 5, the segment sequence includes (2+Q) first text segments. The processor 140 may combine the adjacent first text segments (that is, the first article paragraphs TP_1 and TP_2) in the segment sequence into the first text chunk C5_1. In the example of FIG. 5, the sum of the number of words of the first article paragraphs TP_1 and TP_2 in the first text chunk C5_1 does not exceed the word limit. It should be noted that in other embodiments, if the sum of the number of words of the first article paragraphs TP_1 and TP_2 exceeds the word limit, the processor 140 may respectively identify the first article paragraphs TP_1 and TP_2 as different first text chunks.

Then, the processor 140 may combine 4 sentences SS1_1 to SS1_4 to generate a first text chunk C5_2. The processor 140 may combine the adjacent first text segments (that is, the sentences SS1_1 to SS1_4) in the segment sequence into the first text chunk C5_2. Specifically, in the example, if 5 sentences SS1_1 to SS1_5 are combined into a text chunk, the number of words of the text chunk will exceed the word limit. Therefore, the processor 140 may decide to combine the 4 sentences SS1_1 to SS1_4 into the first text chunk C5_2.

Then, the processor 140 may combine multiple sentences SS1_4 to SS1_Q to generate a first text chunk C5_3. Specifically, in the example, if the sentences SS1_4 to SS1_Q are combined into a text chunk, the number of words of the text chunk will not exceed the word limit. Therefore, the processor 140 may decide to combine the sentences SS1_4 to SS1_Q into the first text chunk C5_3.

It should be noted that in the embodiment, combining multiple texts means sequentially concatenating the texts.

It is worth mentioning that in some embodiments, the first text chunks include a third text chunk and a fourth text chunk. An ending text segment of the third text chunk may be the same as a starting text segment of the fourth text chunk. In other words, different text chunks may include repeated text segments. As shown in the example of FIG. 5, the sentence SS_4 (that is, the ending text segment) of the first text chunk C5_2 (that is, the third text chunk) is the same as the sentence SS_4 (that is, the starting text segment) of the first text chunk C5_3 (that is, the fourth text chunk). The sentence SS_4 is also the ending text segment of the first text chunk C5_2 and the starting text segment of the first text chunk C5_3.

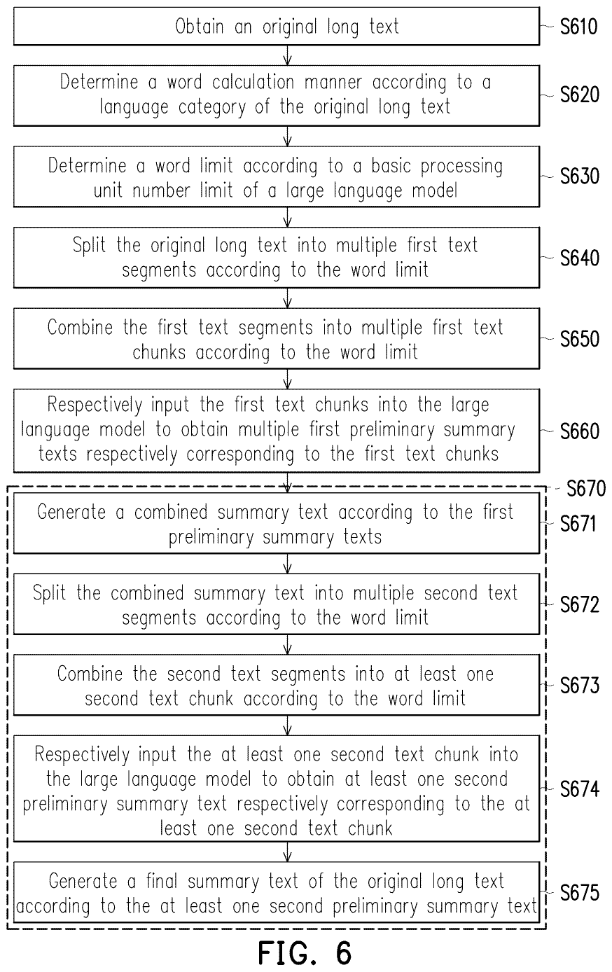

Please refer to FIG. 1 and FIG. 6 at the same time. The method of the embodiment is adapted to the electronic device 100. The detailed steps of the article summary generation method of the embodiment are described below in conjunction with various elements of the electronic device 100.

In step S610, the processor 140 obtains an original long text. In step S620, the processor 140 determines a word calculation manner according to a language category of the original long text. The processor 140 may judge whether the language category of the original long text is a logographic text or a phonographic text. The logographic text is, for example, Chinese or Japanese. The phonographic text is, for example, English. When the language category of the original long text is the logographic text, the processor 140 may count the number of words of the original long text in terms of units of characters. When the language category of the original long text is the phonographic text, the processor 140 may count the number of words of the original long text in terms of units of words. In some embodiments, when the language category of the original long text is the phonographic text, the processor 140 may calculate the number of words of the text according to spacings between words.

In step S630, the processor 140 determines a word limit according to a basic processing unit (token) number limit of a large language model. In detail, the large language model has the basic processing unit (token) number limit. The token number limit is generally between 512 and 4096. For example, a GPT-3 model has a token number limit of 4096. The processor 140 may determine the word limit according to a preset ratio and the token number limit. The preset ratio is also determined based on the language category of the original long text.

For example, the preset ratio between the number of words and a token number of Chinese text is close to 1:1. The preset ratio between the number of words and a token number of English text is between 1:1.1 and 1:1.5. For example, when the token number limit of the large language model is 4096 and the language category of the original long text is Chinese, the processor 140 may determine that the word limit is 4096*0.9. When the token number limit of the large language model is 4096 and the language category of the original long text is English, the processor 140 may determine that the word limit is 4096*0.75.

In step S640, the processor 140 splits the original long text into multiple first text segments according to the word limit. In step S650, the processor 140 combines the first text segments into multiple first text chunks according to the word limit. Each first text chunk includes at least one of the first text segments. In step S660, the processor 140 respectively inputs the first text chunks into the large language model to obtain multiple first preliminary summary texts respectively corresponding to the first text chunks. For the detailed description of the above steps, reference may be made to the above embodiments and will not be described again here.

In step S670, the processor 140 generates the final summary text of the original long text based on the first preliminary summary texts. In the embodiment, step S670 may be implemented as step S671 to step S675.

In step S671, the processor 140 generates a combined summary text according to the first preliminary summary texts. In some embodiments, the processor 140 may combine the first preliminary summary texts to obtain the combined summary text.

In step S672, the processor 140 splits the combined summary text into multiple second text segments according to the word limit. In step S673, the processor 140 combines the second text segments into at least one second text chunk according to the word limit. In other words, the processor 140 may perform text splitting and text segmentation combination again on a combined text of multiple summary texts output by the large language model.

In step S674, the processor 140 respectively inputs the at least one second text chunk into the large language model to obtain at least one second preliminary summary text respectively corresponding to the at least one second text chunk. In step S675, the processor 140 generates a final summary text of the original long text according to the at least one second preliminary summary text. It can be seen that the processor 140 may repeatedly perform preliminary summary combination, the text splitting, and the text segmentation combination until the sum of the number of words of multiple output summaries of the large language model is less than a specific threshold (for example, the word limit determined based on the basic processing unit (token) number limit).

In some embodiments, when the number of the at least one second text chunk is 1, the processor 140 outputs the at least one second preliminary summary text as the final summary text of the original long text. In other words, when the processor 140 performs the text splitting and the text segmentation combination on the combined summary text and obtains only one text chunk, the processor 140 may identify the second preliminary summary text of the text chunk as the final summary text of the original long text.

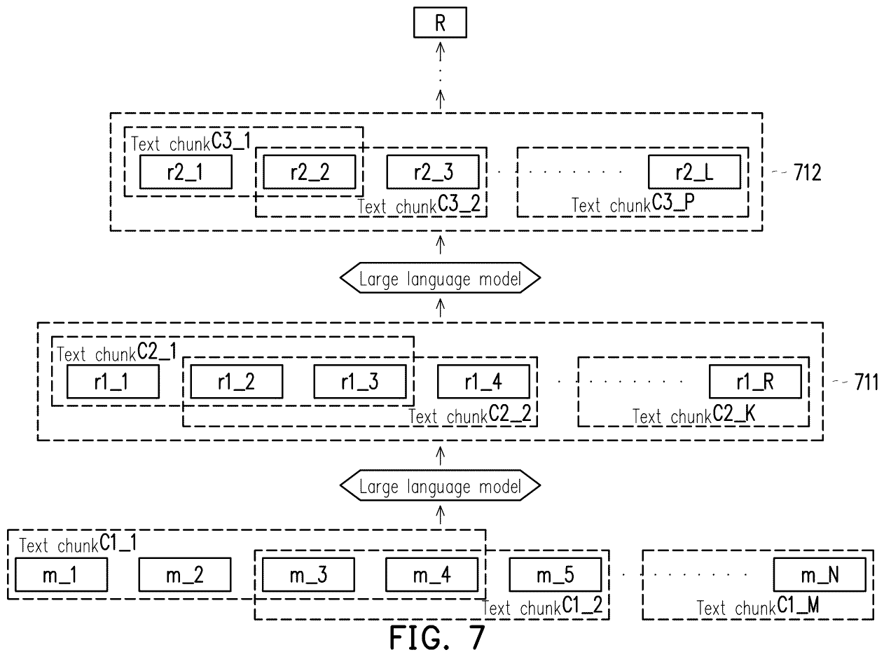

For example, please refer to FIG. 7, which is a schematic diagram of an article summary generation method according to an embodiment of the disclosure. The processor 140 may split a target long text into N text segments m_1 to m_N. The processor 140 may combine the N text segments m_1 to m_N according to the word limit and generate M text chunks C1_1 to C1_M. M and N are integers greater than 0, and N≥M.

Afterwards, the processor 140 may input the text chunk C1_1 including the text segments m_1 to m_4 into the large language model to generate the preliminary summary text of the text chunk C1_1. The processor 140 may input the text chunk C1_2 including the text segments m_3 to m_5 into the large language model to generate the preliminary summary text of the text chunk C1_2. By analogy, the processor 140 may input the text chunk C1_M including the text segment m_N into the large language model to generate the preliminary summary text of the text chunk C1_M.

The processor 140 may combine M preliminary summary texts of the M text chunks C1_1 to C1_M, and generate a combined summary text 711 of the M preliminary summary texts. Afterwards, the processor 140 may split the combined summary text 711 into R text segments r1_1 to r1_R. The processor 140 may combine the R text segments r1_1 to r1_R according to the word limit and generate K text chunks C2_1 to C2_K. R and K are integers greater than 0, and R≥K. The processor 140 may respectively input the K text chunks C2_1 to C2_K into the large language model to generate K preliminary summary texts of the K text chunks C2_1 to C2_K.

The processor 140 may combine the K preliminary summary texts of the K text chunks C2_1 to C2_K, and generate a combined summary text 712. Afterwards, the processor 140 may split the combined summary text 712 into L text segments r2_1 to r2_L. The processor 140 may combine the L text segments r2_1 to r2_L according to the word limit and generate P text chunks C3_1 to C3_P. L and P are integers greater than 0, and L_P. The processor 140 may respectively input the P text chunks C3_1 to C3_P into the large language model to generate multiple corresponding preliminary summary texts. Through repeatedly executing the above operations, the processor 140 may finally obtain a final summary text R of the target long text.

In summary, in the embodiments of the disclosure, the first text chunks of the original long text are sequentially input into the large language model to obtain the first preliminary summary texts respectively corresponding to the first text chunks through the large language model with a text summarization function. Therefore, the final summary text of the original long text may be further generated according to the first preliminary summary texts. The first text chunks are split based on the word limit and an article structure. Based on this, even if the original long text is lengthy and the computing resources of the electronic device are limited, the coherent and high-quality summary text can still be generated. In addition, the text segments within the first text chunks may overlap to achieve understanding between contexts to obtain a reasonable summary content.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An article summary generation method, adapted to an electronic device, the article summary generation method comprising:
obtaining an original long text;
splitting the original long text into a plurality of first text segments according to a word limit;
combining the first text segments into a plurality of first text chunks according to the word limit, wherein each of the first text chunks comprises at least one of the first text segments;
respectively inputting the first text chunks into a large language model to obtain a plurality of first preliminary summary texts respectively corresponding to the first text chunks; and
generating a final summary text of the original long text based on the first preliminary summary texts.

2. The article summary generation method according to claim 1, wherein the step of generating the final summary text of the original long text based on the first preliminary summary texts comprises:
generating a combined summary text according to the first preliminary summary texts;
splitting the combined summary text into a plurality of second text segments according to the word limit;
combining the second text segments into at least one second text chunk according to the word limit;
respectively inputting the at least one second text chunk into the large language model to obtain at least one second preliminary summary text respectively corresponding to the at least one second text chunk; and
generating the final summary text of the original long text according to the at least one second preliminary summary text.

3. The article summary generation method according to claim 2, wherein the step of generating the final summary text of the original long text according to the at least one second preliminary summary text comprises:
when a number of the at least one second text chunk is 1, outputting the at least one second preliminary summary text as the final summary text of the original long text.

4. The article summary generation method according to claim 2, wherein the step of generating the combined summary text according to the first preliminary summary texts comprises:
combining the first preliminary summary texts to obtain the combined summary text.

5. The article summary generation method according to claim 1, wherein the step of splitting the original long text into the first text segments according to the word limit comprises:
splitting the original long text into a plurality of article paragraphs;
when a number of words of a first article paragraph among the article paragraphs is greater than the word limit, splitting the first article paragraph into a plurality of sentences, wherein the first text segments comprise one of the sentences; and
when the number of words of the first article paragraph among the article paragraphs is not greater than the word limit, determining the first article paragraph as one of the first text segments.

6. The article summary generation method according to claim 5, wherein the step of splitting the original long text into the first text segments according to the word limit further comprises:
when a number of words of a first sentence among the sentences is greater than the word limit, splitting the first sentence into a plurality of participles, wherein the first text segments comprise the participles; and
when the number of words of the first sentence among the sentences is not greater than the word limit, determining the first sentence as another one of the first text segments.

7. The article summary generation method according to claim 5, further comprising:
determining a word calculation manner according to a language category of the original long text.

8. The article summary generation method according to claim 1, wherein a sum of a number of words of the first text segments in each of the first text chunks is less than the word limit.

9. The article summary generation method according to claim 1, wherein the first text chunks comprise a third text chunk and a fourth text chunk, and an ending text segment of the third text chunk is the same as a starting text segment of the fourth text chunk.

10. The article summary generation method according to claim 1, further comprising:
determining the word limit according to a basic processing unit (token) number limit of the large language model.

11. An electronic device, comprising:
a storage device, recording a plurality of commands; and
a processing device, connected to the storage device and configured to execute the commands to:
obtain an original long text;
split the original long text into a plurality of first text segments according to a word limit;
combine the first text segments into a plurality of first text chunks according to the word limit, wherein each of the first text chunks comprises at least one of the first text segments;
respectively input the first text chunks into a large language model to obtain a plurality of first preliminary summary texts respectively corresponding to the first text chunks; and
generate a final summary text of the original long text based on the first preliminary summary texts.
